(19) United States
(12) Patent Application Publication
(10) Pub. No.: US 2024/0346172 A1
(43) Pub. Date: Oct. 17, 2024

(54) DATA DISCLOSURE APPARATUS, AND DATA DISCLOSURE METHOD

(71) Applicant: Hitachi, Ltd., Tokyo (JP)

(72) Inventors: Toshihiko KASHIYAMA, Tokyo (JP); Kazuhiko MOGI, Tokyo (JP); Norifumi NISHIKAWA, Tokyo (JP)

(21) Appl. No.: 18/621,181

(22) Filed: Mar. 29, 2024

(30) Foreign Application Priority Data
Apr. 13, 2023 (JP) 2023-065569

(51) Int. Cl. G06F 21/62; G06F 16/2455; G06F 21/60

(52) U.S. Cl. CPC G06F 21/6227; G06F 16/24564; G06F 21/602

(57) ABSTRACT

Data is disclosed only when a utilization purpose is met, and a risk that the disclosed data is referenced for other purposes is reduced. A data disclosure apparatus discloses data in response to a query from a user, and includes at least one computation device, at least one memory resource, and at least one storage device. The computation device receives the query, checks whether or not the query complies with a predetermined rule, searches table data as query processing responding to the query to acquire a result of query execution when the query is confirmed to comply with the predetermined rule, encrypts the result of query execution using a public key corresponding to a private key held by the user, and provides the encrypted result of query execution to the user.

### CLAIM OF PRIORITY

The present application claims priority from Japanese patent application JP 2023-065569 filed on Apr. 13, 2023, the content of which is hereby incorporated by reference into this application.

### BACKGROUND OF THE INVENTION

### 1. Field of the Invention

The present invention relates to a data disclosure apparatus and a data disclosure method.

### 2. Description of Related Art

For example, in a case where a plurality of suppliers supply identical components to a certain manufacturer, it is normally impossible that the competing suppliers share various pieces of information related to the components (material supplier, material cost, manufacturing cost, delivery price, and the like).

However, for example, in the case of an emergency such as a disaster or war, in order to prevent stockout of components, delayed delivery, degraded quality, and the like, the competing suppliers are required to share data related to the components. However, when the data of each of the competing companies is to be disclosed to the other competing companies, a mechanism is required that keeps the data confidential even if the data is accidentally leaked to the outside.

In regard to disclosure and confidentiality of data, for example, Japanese Patent Laid-Open No. 2021-39143 describes “a confidential information processing system that performs data processing on encrypted data of data including confidential information provided to a confidential information processing server from a data holder terminal which owns the data, wherein the confidential information processing server comprises: a processing request execution unit that receives a processing request for the encrypted data; a confidential extraction processing unit that instructs execution of confidential extraction for extracting data that matches with a predetermined condition while the encrypted data is kept encrypted; a trusted part processing unit that decrypts and processes the encrypted data in a safe trusted part using an encryption key that can be used only in the trusted part; and an encrypted data holding unit that stores the encrypted data encrypted with a confidentially extractable cipher with which the confidential extraction can be executed, and when the processing request execution unit receives the processing request, the trusted part processing unit generates a confidential extraction query for performing extraction of data that matches with a condition of a processing target in the processing request by the confidential extraction based on the processing request and the encryption key, the confidential extraction processing unit extracts encrypted data of the processing target while the data is kept encrypted from the encrypted data holding unit by instructing execution of the generated confidential extraction query, the trusted part processing unit decrypts encrypted data of the processing target extracted by the confidential extraction processing unit with the encryption key, and executes data processing requested by the processing request, and the processing request execution unit returns an execution result of the data processing to a transmission source of the processing request.”

Additionally, for example, Japanese Patent Laid-Open No. 2022-137857 describes “a data management device comprising: a determination unit that determines whether secondary data to be generated from source data to be processed complies with a data handling rule that uses statistical information; and a data processing unit that performs processing according to a determination result from the determination unit, wherein the determination unit estimates the statistical information based on the source data to be processed, prior to the generation of the secondary data, and determines whether the secondary data to be generated based on the estimated statistical information complies with the data handling rule, based on whether the secondary data satisfies statistical values of the statistical information, and the data processing unit executes the processing process to generate the secondary data when it is determined that the secondary data complies with the data handling rule, and does not execute the processing process when it is determined that the secondary data does not comply with the data handling rule.”

### SUMMARY OF THE INVENTION

According to the technique described in Japanese Patent Laid-Open No. 2021-39143, what is generally called searchable encryption can be used to lay data open. However, the technique fails to check whether a user utilizes data provided to the user side only within the range of the original utilization purpose.

According to the technique described in Japanese Patent Laid-Open No. 2022-137857, the processing process of processing the source data into the secondary data is not executed when the generated secondary data does not comply with the data handling rule, enabling a reduction in the number of steps for preparing data. However, any person can reference the secondary data provided to the user side for any purpose.

In view of the circumstances described above, an object of the present invention is to disclose data only when the utilization purpose is met and to enable a reduction in risk that the disclosed data is referenced for other purposes.

The present application includes a plurality of means for solving at least part of the problems described above, and examples of the means are as follows.

To solve the problems described above, according to an aspect of the present invention, there is provided a data disclosure apparatus that discloses data in response to a query from a user, the data disclosure apparatus including at least one computation device, at least one memory resource, and at least one storage device, in which the computation device receives the query, checks whether or not the query complies with a predetermined rule, searches table data as query processing responding to the query to acquire a result of query execution when the query is confirmed to comply with the predetermined rule, encrypts the result of query execution using a public key corresponding to a private key held by the user, and provides the encrypted result of query execution to the user.

According to the present invention, the data can be disclosed only when the utilization purpose is met, and the risk that the disclosed data is referenced for other purposes can be reduced.

Problems, configurations, and effects other than those described above will be clarified from the description of embodiments below.

### BRIEF DESCRIPTION OF THE DRAWINGS

FIG. 1 is a diagram illustrating a configuration example of a data disclosure system according to a first embodiment of the present invention;

FIG. 2 is a diagram illustrating an example of a rule management table;

FIG. 3 is a diagram illustrating an example of a user table;

FIG. 4 is a diagram illustrating an example of a public key management table;

FIG. 5 is a diagram illustrating an example of a rule complying public key correspondence management table;

FIG. 6 is a diagram illustrating an example of a private key management table;

FIG. 7 is a flowchart for describing an example of data disclosure processing corresponding to a first embodiment;

FIG. 8 is a diagram illustrating a display example of a UI screen;

FIG. 9 is a diagram illustrating a display example of the UI screen;

FIG. 10 is a diagram illustrating a configuration example of a data disclosure system according to a second embodiment of the present invention; and

FIG. 11 is a flowchart for describing an example of data disclosure processing corresponding to the second embodiment.

### DESCRIPTION OF THE PREFERRED EMBODIMENTS

A plurality of embodiments of the present invention will be described below on the basis of the drawings. Note that, in all the drawings for describing each embodiment, the same members are in principle denoted by the same reference numerals, and repeated descriptions thereof are omitted. Additionally, in the embodiments below, the components (including element steps and the like) thereof are not necessarily essential unless expressly stated otherwise, except in a case where the components are in principle obviously considered to be essential, and the like. Further, when phrases “formed by A,” “made by A,” “have A,” and “include A” are used herein, elements other than A are not excluded except in a case where limitation to that element is expressly stated, or the like. Similarly, when referring to the shapes, positional relations, and the like of the components or the like, the embodiments below include shapes and the like substantially approximate or similar to those described above unless expressly stated otherwise, except in a case where the embodiments are in principle obviously considered not to include such shapes and the like, and the like.

### <Configuration Example of Data Disclosure System 10-1 According to First Embodiment of Present Invention>

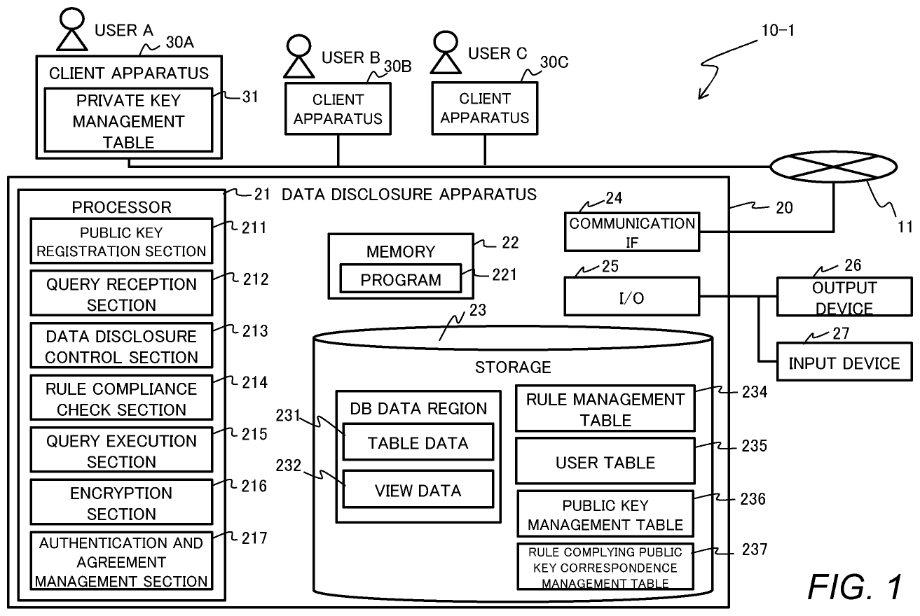

FIG. 1 illustrates a configuration example of a data disclosure system 10-1 according to a first embodiment of the present invention.

For example, in response to queries from users A, B, and C, the data disclosure system 10-1 discloses data corresponding to the queries only when the utilization purpose of referencing of the data meets a predetermined rule.

The data disclosure system 10-1 includes a data disclosure apparatus 20, and client apparatuses 30A to 30C connected to the data disclosure apparatus 20 via a network 11.

The network 11 is a bidirectional communication network such as a local area network (LAN), a wide area network (WAN), or the Internet. The client apparatuses 30A to 30C are general computers such as personal computers.

The data disclosure apparatus 20 is formed by a general computer such as a server computer or a personal computer including a processor 21 such as a central processing unit (CPU), a memory 22 such as a dynamic random access memory (DRAM), a storage 23 such as a hard disk drive (HDD) or a solid state drive (SSD), and a communication interface (IF) 24 such as an Ethernet (trademark) card or a Wi-Fi (trademark) adapter, as well as an output device 26 such as a display and an input device 27 such as a keyboard, a mouse, and a media drive which are connected to the data disclosure apparatus 20 via an I/O 25. The processor 21, the memory 22, and the storage 23 correspond to a computation device, a memory resource, and a storage device, respectively, in the present invention.

The processor 21 executes a program 221 stored in the memory 22 to realize functional blocks including a public key registration section 211, a query reception section 212, a data disclosure control section 213, a rule compliance check section 214, a query execution section 215, an encryption section 216, and an authentication and agreement management section 217.

Note that the program 221 may be stored in advance in the memory 22 or may be stored in the memory 22 by being read out from the storage 23, being input from the input device 27, or being downloaded from another apparatus via the communication IF 24 as necessary. The public key registration section 211 registers, in a public key management table 236, at least one public key transmitted from the user.

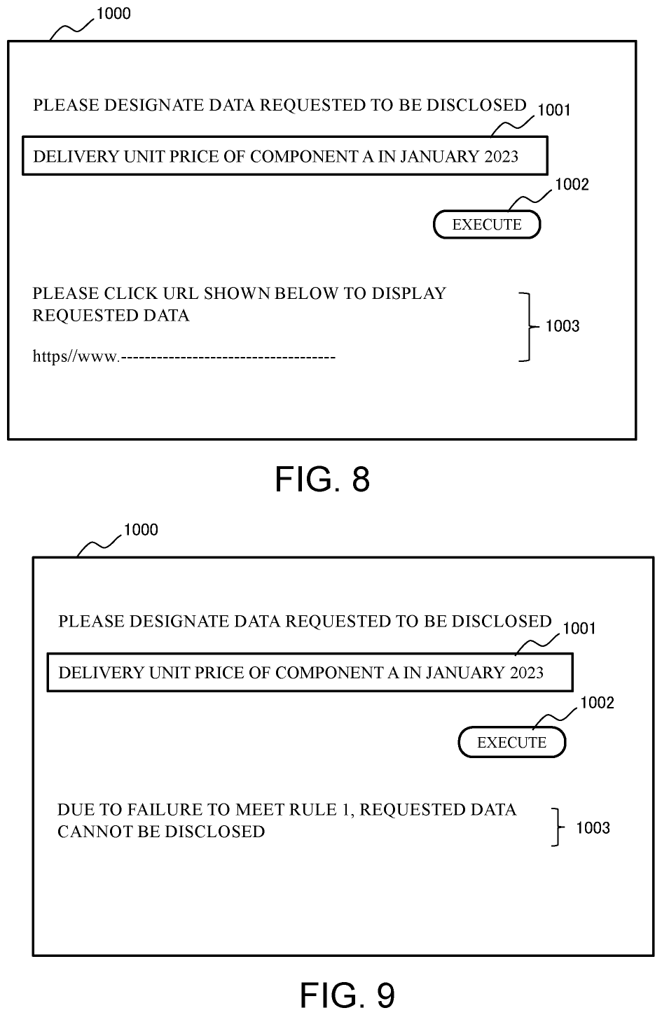

The query reception section 212 receives a query input to a UI screen 1000 (FIG. 8) by the user, and issues and registers a query ID in a rule complying public key correspondence management table 237.

The data disclosure control section 213 causes the UI screen 1000 (FIG. 8), to which the user inputs a query and which presents a result of query execution, to be displayed on the client apparatuses 30A to 30C.

The rule compliance check section 214 checks whether or not the query from the user or an execution result for the query complies with a predetermined rule, and registers a check result for the query in the rule complying public key correspondence management table 237 in association with the query ID.

The query execution section 215 executes query processing corresponding to the query from the user. For example, as query processing, the query execution section 215 extracts and acquires, from table data 231, data matching the query. Then, the query execution section 215 registers the result of query execution (data extracted and acquired from the table data 231) in the rule complying public key correspondence management table 237 in association with the query ID.

The encryption section 216 encrypts the result of query execution by the query execution section 215, using a public key registered in the public key management table 236 in association with a user ID of the user who has input the corresponding query. Note that, in a case where a plurality of public keys are registered in the public key management table 236 in association with the same user ID, the encryption section 216 may select and use one of the public keys for encryption.

The authentication and agreement management section 217 acquires user authentication information from a predetermined authentication server and registers the user authentication information in the rule complying public key correspondence management table 237. Providing the item of user authentication information allows data to be disclosed only to the authenticated user. Additionally, the authentication and agreement management section 217 acquires agreement of the data owner related to disclosure of the data to the user who has transmitted the query, and registers the agreement in the rule complying public key correspondence management table 237. Providing the item of agreement of the data owner allows the data to be disclosed only when agreement has been obtained from the data owner.

The storage 23 stores the table data 231 and view data 232 in a DB data region thereof. In the table data 231, data to be disclosed to the users A, B, C, and the like is recorded. By storing the table data 231 in the storage 23, the data to be disclosed can be centrally managed. The view data 232 is the result of query execution by the query execution section 215, and is used in a case where a previously executed query is received again. Recording the view data 232 allows omission of query processing in a case where a previously executed query is received again. Additionally, the storage 23 stores a rule management table 234, a user table 235, the public key management table 236, and the rule complying public key correspondence management table 237.

The rule management table 234 is stored in the storage 23 in advance. In the rule management table 234, a rule related to queries and a rule related to the result of query execution are registered in advance.

The user table 235 is stored in the storage 23 in advance. In the user table 235, attributes of the user (country (district), organization, and the like to which the user belongs) are registered.

The public key registration section 211 registers, in the public key management table 236, a public key transmitted from the user.

In the rule complying public key correspondence management table 237, various pieces of information that are used during a process of processing the query transmitted from the user are registered. The details of each table will be described below.

The communication IF 24 is connected to the client apparatuses 30 and the like via the network 11 to communicate various kinds of data and information to the client apparatuses 30 and the like. The I/O 25 outputs various kinds of data to the output device 26 and receives data input through the input device 27.

A program to be executed by the processor 21 is provided to the data disclosure apparatus 20 via a removable medium (CD-ROM, flash memory, or the like) or the network and stored in the storage 23, which is a non-transitory storage medium. Accordingly, the data disclosure apparatus 20 may include an interface for loading data from the removable medium.

Further, the data disclosure apparatus 20 is a computer system configured physically on one computer or configured on a plurality of logically or physically configured computers, and may operate on a virtual computer constructed on a plurality of physical computer resources. For example, a plurality of programs realizing functions of the data disclosure apparatus 20 may each operate on a separate physical or logical computer or may be combined into a program operating on one physical or logical computer.

The client apparatuses 30A to 30C used by the respective users A, B, and C are general computers such as personal computers. The client apparatus 30A includes a private key management table 31 managing a private key (decryption key) corresponding to the public key (encryption key) registered in the data disclosure apparatus 20 by the client apparatus 30A. The details of the private key management table 31 will be described below. This also applies to the client apparatuses 30B and 30C.

In the following description, in a case where the users A, B, and C and the client apparatuses 30A to 30C need not be individually distinguished from one another, the users A, B, and C and the client apparatuses 30A to 30C are simply referred to as the user and the client apparatus 30.

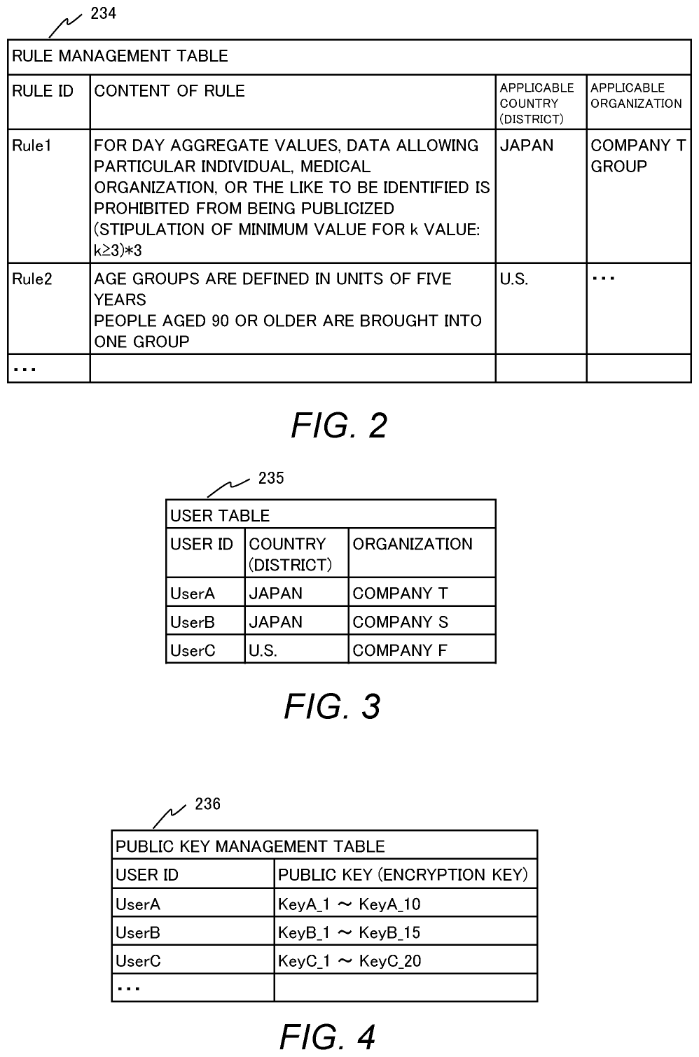

Next, FIG. 2 illustrates an example of the rule management table 234. In the rule management table 234, information of the items of content of the rule, an applicable country (district), and an applicable organization is registered in association with the rule ID. However, the items recorded in the rule management table 234 are not limited to the examples described above.

In the item of the rule ID, identification information that is used to uniquely identify the rule is registered. In the items of the applicable country (district) and the applicable organization, the attributes (country (district) and organization) of the user to which the rule is applied are registered. By providing the items of the applicable country (district) and the applicable organization, the target to which the rule is applied can be set.

For example, FIG. 2 indicates that the rule for which the rule ID is “Rule1” includes the content “For day aggregate values, . . . ” the applicable country “Japan,” and the applicable organization “Company T group.”

Next, FIG. 3 illustrates an example of the user table 235. In the user table 235, information of the items of the country (district) and the organization to which the user belongs is registered in association with the user ID. However, the items registered in the user table 235 are not limited to the examples described above. In the item of the user ID, identification information that is used to uniquely identify the user is registered.

For example, FIG. 3 indicates that the user for whom the user ID is “UserA” belongs to the country “Japan” and the organization “Company T.”

Next, FIG. 4 illustrates an example of the public key management table 236. In the public key management table 236, the public key transmitted from the user is registered in association with the user ID. However, the items registered in the public key management table 236 are not limited to the examples described above.

For example, FIG. 4 indicates that 10 public keys “KeyA_1 to KeyA_10” are transmitted by the user for whom the user ID is “UserA.” The user can register a plurality of public keys and holds private keys corresponding to the respective public keys. Thus, even if some of the private keys are leaked, leakage of the disclosed data can be inhibited by encrypting data to be disclosed using the public keys corresponding to the private keys not leaked.

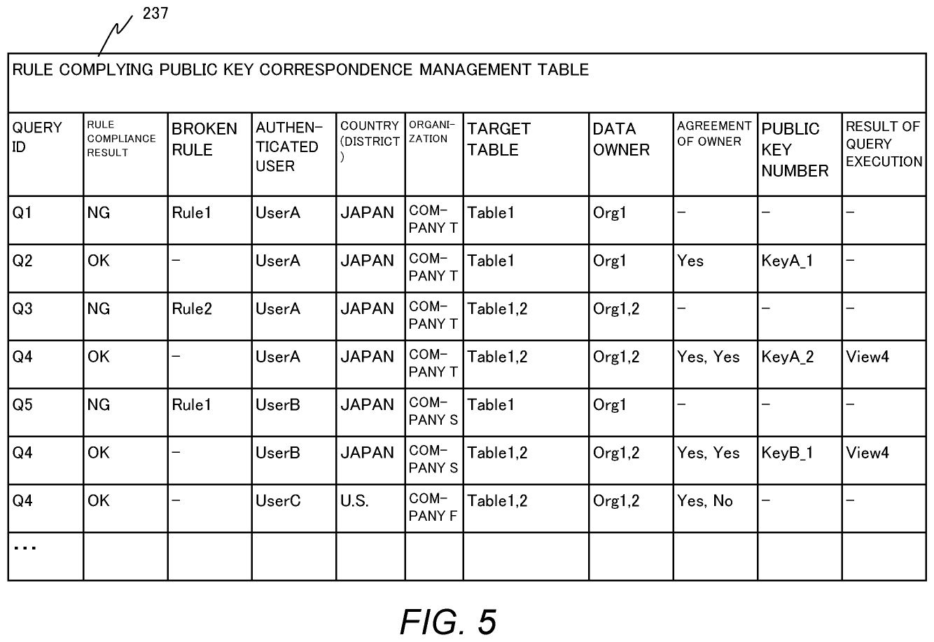

Next, FIG. 5 illustrates an example of the rule complying public key correspondence management table 237. In the rule complying public key correspondence management table 237, information of the following items is registered in association with the query ID: rule compliance result, broken rule, authenticated user, country (district), organization, target table data, data owner, owner agreement, public key number, and result of query execution.

In the item of the query ID, identification information that is used to uniquely identify the query transmitted from the user is registered. In the item of the rule compliance result, information that indicates whether or not the query complies with all the rules applied to the query is registered. In the item of the broken rule, the rule ID of the rule that is not complied with by the query is registered. In the items of the authenticated user, country (district), and organization, the user ID of the user who has transmitted the query, and the country (district) and organization to which the user belongs are registered. In the item of the target table, identification information for the table data 231 including the data requested by the query is registered. In the items of the data owner and the owner agreement, identification information for the owner of the table data 231 requested by the query and the presence or absence of agreement of the owner for data disclosure are registered. In the item of the public key number, the number of the public key used to encrypt data when the data is disclosed in response to the query is registered. In the item of the result of query execution, a path to the view data 232 representing the result of the query is registered.

For example, FIG. 5 indicates that the query for which the query ID is “Q1” does not comply with the rule “Rule1” and the query has not been executed. Additionally, for example, FIG. 5 indicates that the query for which the query ID is “Q2” has the rule compliance result “OK” and has no problem, and thus the query has been executed, with the result of query execution encrypted using the public key “KeyA_1” and disclosed to the user. Further, for example, FIG. 5 indicates that the query for which the query ID is “Q4” has been transmitted from the user IDs “UserA,” “UserB,” and “UserC,” and the query from one of “UserA” and “UserB” is executed, with the result “View4” of execution of the query from the one user saved as the view data 232 and used as the result of query execution for the other user. Additionally, FIG. 5 indicates that the query “Q4” from “UserC” is not executed because “Org2” that is the owner of the target table “Table2” has not agreed to disclose the data to “UserC” or the attributes thereof (country and organization).

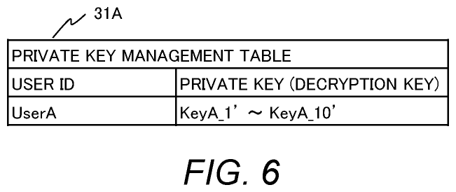

Next, FIG. 6 illustrates an example of the private key management table 31A. In the private key management table 31A, the private key for decryption of the user is registered in association with the user ID.

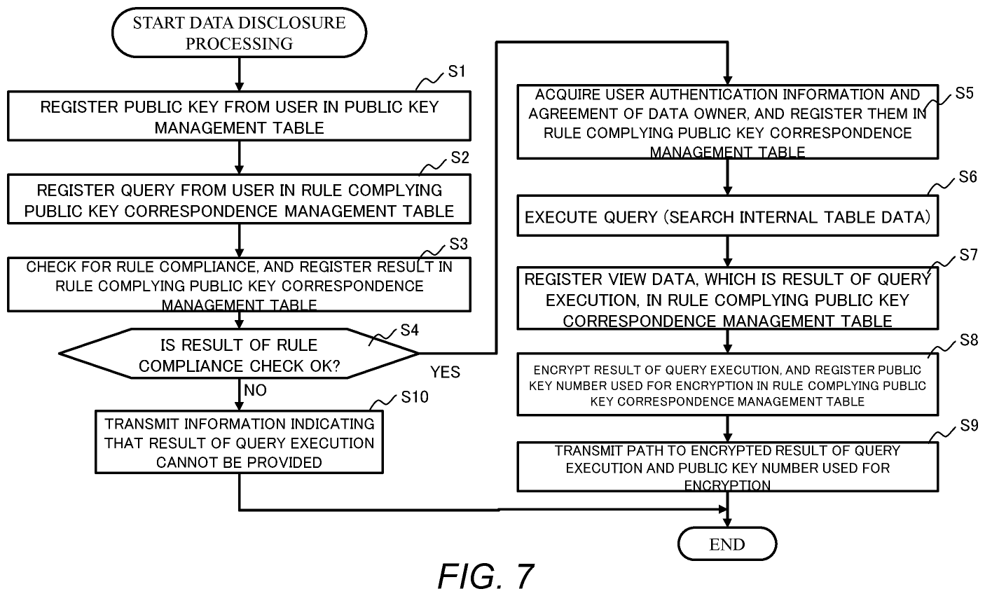

Next, FIG. 7 is a flowchart for describing an example of data disclosure processing according to the first embodiment.

As prerequisites for the data disclosure processing, the table data 231, the rule management table 234, and the user table 235 are assumed to be already stored in the storage 23 of the data disclosure apparatus 20. Additionally, the UI screen 1000 (FIG. 8) is assumed to be displayed on the client apparatus 30 by the data disclosure control section 213.

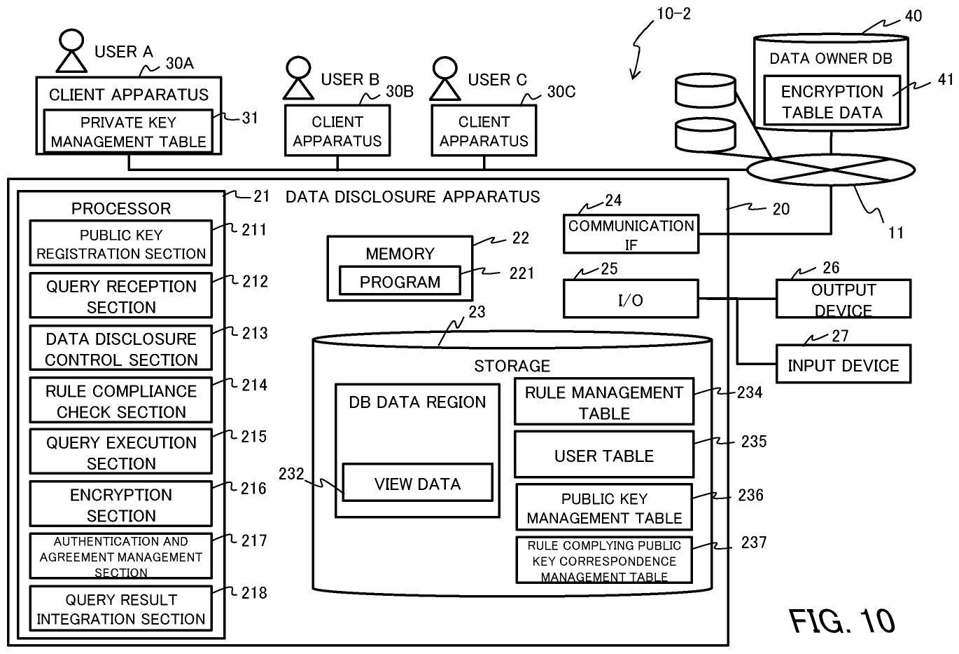

FIGS. 8 and 9 illustrate display examples of the UI screen 1000 displayed on the client apparatus 30. The UI screen 1000 is provided with an input field 1001 to which the user inputs a query, an “execution” button 1002 used by the user to instruct execution of the query, and a display field 1003 used to display the result of query execution. Note that FIG. 8 is a display example in the case where the result of query execution is obtained, whereas FIG. 9 is a display example in the case where the result of query execution is not obtained.

The data disclosure processing is initiated when, in response to the user inputting a query into the input field 1001 of the UI screen 1000 and operating the “execution” button 1002, the query and the public key of the user are transmitted to the data disclosure apparatus 20.

First, the public key registration section 211 registers the public key of the user in the public key management table 236 (step S1). Then, the query reception section 212 issues a query ID for the query from the user and registers the query ID in the rule complying public key correspondence management table 237 (step S2).

Then, the rule compliance check section 214 references the user table 235 to check the attributes (country and organization) of the user, and references the rule management table 234 to specify the rule to be applied to the query from the user. Then, the rule compliance check section 214 checks whether or not the query complies with the rule, and registers information of the items of the rule compliance result, broken rule, authenticated user, country (district), organization, target table, and data owner in the rule complying public key correspondence management table 237 in association with the query ID of the query (step S3). However, depending on the content of the rule, whether or not the rule is complied with may not be determined unless the result of query execution is checked. In that case, it is sufficient if the query execution section 215 executes query processing according to the query, and on the basis of the result of query execution, the rule compliance check section 214 determines whether or not the query complies with the rule.

Then, the rule compliance check section 214 determines whether or not the compliance of the query with the rule has successfully been confirmed in step S3 (step S4).

Here, when the rule compliance check section 214 determines that the query has successfully been confirmed to comply with the rule (YES in step S4), then the authentication and agreement management section 217 acquires, from a predetermined server, for example, user authentication information used to check validity of the user having transmitted the query. The authentication and agreement management section 217 also acquires, from the data owner, agreement information representing the presence or absence of agreement of the data owner for data provision to the user. Then, the authentication and agreement management section 217 registers the user authentication information and the agreement information in the rule complying public key correspondence management table 237 in association with the query ID of the query (step S5).

Then, the query execution section 215 executes query processing corresponding to the query. Specifically, data matching the query is extracted and acquired from the table data 231 stored in the DB data region of the storage 23 (step S6). Note that, if the query processing corresponding to the query has already been executed in step S3 described above, then in step S6, the query processing may be omitted, and the result of query execution obtained in step S3 may be used.

Then, the query execution section 215 stores the result of query execution (data extracted and acquired from the table data 231) in the DB data region of the storage 23 as the view data 232, and registers a path to the view data 232 in the rule complying public key correspondence management table 237 (step S7).

Then, the encryption section 216 acquires, from the public key management table 236, the public key corresponding to the user who has transmitted the query, and uses the public key as an encryption key to encrypt the result of query execution. Further, the encryption section 216 registers the number of the public key in the rule complying public key correspondence management table 237 (step S8).

Then, the data disclosure control section 213 transmits, to the client apparatus 30, a path (uniform resource locator (URL)) to the encrypted result of query execution and the number of the public key used for encryption (step S9). In response, the client apparatus 30 displays the path (URL) to the encrypted result of query execution in the display field 1003 of the displayed UI screen 1000 (FIG. 8). When the user operates the path, the encrypted result of query execution is downloaded to the client apparatus 30 and decrypted using a decryption key corresponding to the public key used for encryption, to be presented to the user.

Note that, when the rule compliance check section 214 determines in step S4 that the compliance of the query with the rule has failed to be confirmed (NO in step S4), then the data disclosure control section 213 transmits, to the client apparatus 30, information indicating that the result of query execution cannot be provided (step S10). In response, the client apparatus 30 displays a message indicating that the result of query execution cannot be provided in the display field 1003 of the displayed UI screen 1000 (FIG. 9). The data disclosure processing according to the first embodiment has been described.

According to the data disclosure processing described above, data can be disclosed in response only to the query complying with the predetermined rule. Note that, when the data is to be disclosed, the encrypted data that can only be decrypted using the private key managed by the user having transmitted the query is provided, and therefore, even if the encrypted data is externally leaked, the content of the encrypted data can be inhibited from being referenced.

### <Configuration Example of Data Disclosure System 10-2 According to Second Embodiment of Present Invention>

Next, FIG. 10 illustrates a configuration example of a data disclosure system 10-2 according to a second embodiment of the present invention.

In contrast to the data disclosure system 10-1 (FIG. 1), the data disclosure system 10-2 additionally includes a query result integration section 218 as a functional block realized by the processor 21 of the data disclosure apparatus 20. Moreover, the data disclosure system 10-2 includes encryption table data 41 stored in a data owner DB 40 connected to the network 11 instead of the table data 231 stored in the storage 23 in the data disclosure system 10-1. Note that the number of data owner DBs 40 is not limited to one and that a plurality of data owner DBs 40 may be present.

The components of the data disclosure system 10-2 other than the query result integration section 218, the data owner DB 40, and the encryption table data 41 are the same as those of the data disclosure system 10-1, and are denoted by the same reference numerals. Accordingly, description of these components is omitted as appropriate.

The query execution section 215 and the data owner DB 40 in the data disclosure system 10-2 can use what is generally called a searchable encryption technique to extract and acquire data corresponding to a query from the encrypted encryption table data 41 while the data is in an encrypted state.

The query result integration section 218 uses a decryption key held in advance to decrypt and integrate the encrypted results of query execution extracted and acquired from the encryption table data 41 in at least one data owner DB 40.

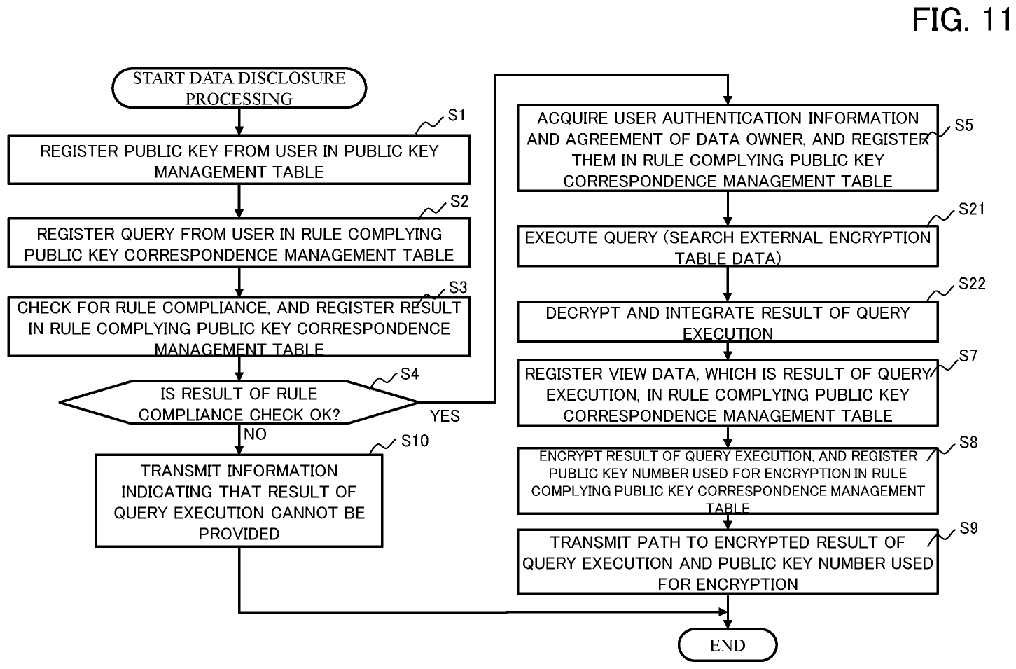

Next, FIG. 11 is a flowchart for describing an example of data disclosure processing according to the second embodiment.

The data disclosure processing includes steps S21 and S22 with which step S6 of the data disclosure processing (FIG. 7) according to the first embodiment is replaced. Steps S1 to S5 and S7 to S10 are similar to those in the data disclosure processing (FIG. 7) according to the first embodiment, and description thereof is omitted as appropriate.

After step S5, the query execution section 215 executes the query. Specifically, the query execution section 215 extracts and acquires data corresponding to the query from the encryption table data 41 stored in the data owner DB 40 (step S21). Then, the query result integration section 218 uses the decryption key held in advance to decrypt and integrate the encrypted result of query execution, which is the result of query execution by the query execution section 215 (step S22).

Then, the query execution section 215 stores the decrypted and integrated result of query execution in the DB data region of the storage 23 as the view data 232, and registers a path to the view data 232 in the rule complying public key correspondence management table 237 (step S7).

Processing steps similar to steps S8 to S10 in FIG. 7 are subsequently executed. The data disclosure processing according to the second embodiment has been described.

With the data disclosure processing according to the second embodiment described above, effects similar to those of the first embodiment can be obtained, and data to be disclosed (table data) can be managed while the data is in the encrypted state in the data owner DB 40.

The present invention is not limited to the embodiments described above, and many variations of the embodiments are possible. For example, the embodiments described above have been described in detail for easy-to-understand description of the present invention, and do not necessarily include all of the configurations described. Additionally, a part of the configuration of a certain embodiment can be replaced with or added to the configuration of another embodiment.

Further, part or all of the configurations, functions, processing sections, processing means, and the like described above may be implemented in hardware by, for example, being designed in an integrated circuit. In addition, the configurations, functions, and the like described above may be implemented in software by a processor interpreting and executing a program for realizing the functions. Information such as a program, a table, or a file which realizes each function can be placed in a recording device such as a memory, a hard disk, or an SSD, or in a recording medium such as an IC card, an SD card, or a DVD. Furthermore, control lines and information lines illustrated are considered necessary for description, and not all the control lines and information lines on products are illustrated. In actuality, substantially all the configurations may be considered to be connected to one another.

What is claimed is:

1. A data disclosure apparatus that discloses data in response to a query from a user, the data disclosure apparatus comprising:
at least one computation device;
at least one memory resource; and
at least one storage device, wherein
the computation device
receives the query,
checks whether or not the query complies with a predetermined rule,
searches table data as query processing responding to the query to acquire a result of query execution when the query is confirmed to comply with the predetermined rule,
encrypts the result of query execution using a public key corresponding to a private key held by the user, and
provides the encrypted result of query execution to the user.

2. The data disclosure apparatus according to claim 1, wherein
the computation device
receives at least one public key from the user and registers the public key in the storage device, and
provides the user with information of the public key used for encryption of the result of query execution.

3. The data disclosure apparatus according to claim 1, wherein
the computation device searches the table data stored in the storage device to acquire the result of query execution.

4. The data disclosure apparatus according to claim 1, wherein
the computation device
searches the table data that is in an encrypted state and stored in at least one database connectible to the data disclosure apparatus via a network, to acquire the result of query execution in an encrypted state, and
decrypts and integrates the at least one result of query execution in the encrypted state acquired from the database.

5. The data disclosure apparatus according to claim 1, wherein
the computation device specifies the rule to be applied to the query on a basis of an attribute of the user.

6. The data disclosure apparatus according to claim 1, wherein
the computation device executes the query processing only when the user is authenticated.

7. The data disclosure apparatus according to claim 1, wherein
the computation device executes the query processing only when agreement for disclosure of the data to the user is obtained from an owner of the table data.

8. The data disclosure apparatus according to claim 1, wherein
the computation device
stores the result of query execution in the storage device, and,
in a case where a query corresponding to the result of query execution stored in the storage device is received again, omits the query processing and uses the result of query execution stored in the storage device.

9. A data disclosure method executed by a data disclosure apparatus that discloses data in response to a query from a user,
the data disclosure apparatus including
at least one computation device,
at least one memory resource, and
at least one storage device,
the data disclosure method comprising:
by the computation device, receiving the query;
by the computation device, checking whether or not the query complies with a predetermined rule;
by the computation device, searching table data as query processing responding to the query to acquire a result of query execution when the query is confirmed to comply with the predetermined rule;
by the computation device, encrypting the result of query execution using a public key corresponding to a private key held by the user; and
by the computation device, providing the encrypted result of query execution to the user.
